(19) United States
(12) Patent Application Publication
(10) Pub. No.: US 2024/0428275 A1
(43) Pub. Date: Dec. 26, 2024

(54) FOUNDATION MODEL INTEGRATIONS FOR PERSONALIZED ENGAGEMENT WITH SOFTWARE APPLICATIONS

(71) Applicant: Microsoft Technology Licensing, LLC, Redmond, WA (US)

(72) Inventors: Kristina Annika LUUS, Dublin (IE); Jack David TOBIN, Kildare (IE); Javier David CARRILLO ATANACIO, Baltinglass (IE); Ingrid PEREZ AGUILERA, Dublin (IE)

(21) Appl. No.: 18/339,848

(22) Filed: Jun. 22, 2023

(51) Int. Cl. G06Q 30/0201

(52) U.S. Cl. CPC G06Q 30/0201

(57) ABSTRACT

Technology is disclosed herein for a foundation model service integration for personalized engagement with respect to an application service. In an implementation, a computing apparatus receives natural language input from a user relating to a job to be performed by one or more applications. The computing apparatus receives a targeted portion generated by an AI engine which includes information relating to the user with respect to the one or more applications. The computing apparatus generates a prompt for a foundation model service including a global portion and a targeted portion. The prompt tasks the foundation model service with identifying one or more tasks relating to the job and identifying a recommended application in association with the task. The computing apparatus enables display of the one or more task and the one or more recommended applications from the foundation model service in a user interface.

### TECHNICAL FIELD

Aspects of the disclosure are related to the field of computer hardware and software solutions, and in particular to integrations between software applications and large language model services.

### BACKGROUND

When a new user subscribes for an application or suite of applications, the first day of the subscription is a crucial business opportunity which may determine a user's lifetime value as they will either engage with an application in a lasting way or fail to do so. New users in particular must overcome a number of barriers which may prevent them from onboarding effectively, ranging from understanding whether the software will be suitable for their needs, to figuring out which application to use to achieve a specific task, to completing the task itself within the application environment. While quick-start guides, user manuals, and other documentation may be available to the new users, these are often neglected by users who regard them as tedious, time-consuming, or difficult to follow, and all the more so when the application interface varies from one version to the next. Moreover, when documentation is available, it may not be sufficiently responsive to the user's task.

In addition, customers vary widely in terms of their technical knowledge, familiarity with software, and ability to complete tasks in new software. For example, a novice user may lack the vocabulary to properly inquire about whether a particular functionality exists within an application. Moreover, more seasoned users tend to learn new application-related skills by posing their queries to a community of other users, but the community of other users may have incomplete information with respect to what a particular application can accomplish. In these types of scenarios, the application publisher risks losing customer engagement, while the customer loses not only the opportunity to accomplish their task but also the opportunity to become a more proficient and more productive user.

### OVERVIEW

Technology is disclosed herein for a system for and methods of operating a computing apparatus for a foundation model integration for personalized engagement. In an implementation, a computing apparatus receives natural language input from a user relating to a job to be performed by one or more applications. The computing apparatus receives a targeted portion generated by an artificial intelligence (AI) engine which includes information relating to the user with respect to the one or more applications. The computing apparatus generates a prompt for a foundation model service including a global portion and a targeted portion. The prompt tasks the foundation model service with identifying one or more tasks relating to the job and identifying a recommended application in association with the task. The computing apparatus enables display of the one or more task and the one or more recommended applications from the foundation model service in a user interface.

In an implementation, the information relating to the user includes a skill level of the user with respect to the one or more applications. In an implementation, the targeted portion includes information relating to a subscription of the user. In some implementations, the targeted portion also includes an offer to be made to the user with respect to the user's subscription status. In an implementation, the targeted portion includes functionalities of each of the one or more applications relating to the job.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment of a system for a foundation model integration for personalized engagement with respect to an application environment in an implementation.

FIG. 2 illustrates a method of operating a foundation model integration for personalized engagement with respect to an application environment in an implementation.

FIG. 3 illustrates a system architecture for a foundation model integration for personalized engagement with respect to an application environment in an implementation.

FIGS. 4A and 4B illustrate operational scenarios of a foundation model integration for personalized engagement with respect to an application environment in an implementation.

FIG. 5 illustrates an operation architecture for an LLM integration for personalized engagement with respect to an application environment in an implementation.

FIG. 6 illustrates an exemplary operational scenario of a foundation model integration for personalized engagement with respect to an application environment in an implementation.

FIG. 7 illustrates a prompt template for a foundation model integration for personalized engagement with respect to an application environment in an implementation.

FIG. 8 illustrates a sample output from an LLM service from an LLM integration for personalized engagement with respect to an application environment in an implementation.

FIG. 9 illustrates a computing system suitable for implementing the various operational environments, architectures, processes, scenarios, and sequences discussed below with respect to the other Figures.

### DETAILED DESCRIPTION

Various implementations are disclosed herein for the integration of a foundation model service an application environment to generate personalized recommendations for users with respect to accomplishing a job or task using one or more software applications. The recommendations are personalized or tailored by the foundation model service according to enriched context generated for the foundation model service by an artificial intelligence (AI) engine. The enriched context generated by the AI engine can include information relating to functionalities of the available applications, user-specific contextual information, content items available for recommendation when appropriate, and business considerations. The foundation model service is tasked with generating recommendations responsive to the user query according to the enriched context. In an implementation, the foundation model service hosts a foundation model, such as a large language model (LLM) hosted by an LLM service.

In an implementation, an application service queries a user about a project, goal, or job the user wishes to accomplish by means of a software application. For example, the user may wish to create a household budget, plan a vacation, create a Christmas card, manage a team project, etc. The application service generates a prompt to elicit a reply from the foundation model service (e.g., an LLM service) including recommendations for accomplishing the job by means of one or more software applications. The recommendations include one or more tasks identified as being related to or associated with the job specified in the user input and a software application for accomplishing each of the tasks. Upon receiving the reply from the foundation model service, the application service configures a display of the recommendations to the user in the user interface. In some implementations, the application service displays graphical input devices (e.g., buttons) which allow the user to select a recommendation, such as launching a recommended application or starting a free trial of an application. When the user elects to launch an application, the application service sends, to an AI engine of the application, information relating to the task which was recommended by the foundation model service, such as a particular tool or functionality to accomplish the task, an indication of the user's skill level, and/or a design or template of the application relating to the task.

To generate the prompt for the foundation model service, the application service configures and assembles at least two prompt portions. The prompt portions include a global or background portion which includes rules for how the foundation model service is to respond to the prompt, assigns a persona to the foundation model service, specifies the particular content the foundation model service is to generate, and provides examples of the types of output that is expected.

The prompt portions also include a user-specific or targeted portion generated by an artificial intelligence (AI) engine of the application service based on user data and application information. The targeted portion provides enriched contextual information for the foundation model service in a natural language format to use in tailoring its response to the prompt. For example, the response or recommendations generated by the foundation model service regarding a particular job may vary depending on the level of proficiency of the user or on whether the application is available to the user according to the user's software subscription (or lack of). The AI engine operates in association with the application service and receives the user data and application information as well as other considerations for the prompt from the application service, such as from one or more context datastores of the application service. By incorporating the AI-generated targeted portion in the prompt to the foundation model service, the foundation model service can provide creative, personalized recommendations to the user for accomplishing the user's job.

In various implementations, the personalized or targeted portion of the prompt generated by the AI engine includes one or more applications or application functionalities identified by the AI engine as relating to the user input. Environments in which a user may post a query for seeking assistance in accomplishing a job can include, in some implementations, a suite of productivity applications, such as a word processing application, a spreadsheet application, a presentation application, a collaboration application, an email application, a calendar or scheduling application, a drawing application, a note-taking application, an image editing application, database application, and so on. The suite of applications may be specific to a particular field, such as creativity and design applications relating to photography, videography, graphic design, and illustration, with each application including a broad range of functionality. In some implementations, the environment may be an integrated development environment (IDE) including a software development application with plugins or software components available for additional coding functions.

In addition to the various kinds of applications and application suites for which the AI engine tailors the enriched context, there is variability in the skill levels of users. The user may be a novice or experienced user who wishes to use or to know how to use an application or an application suite to accomplish a goal or to enhance the performance of a task. The AI engine tailors the enriched context according to the skill level of the user on the basis of metrics such as application usage and subscription status (e.g., license type, subscription plan or level, or lack of a subscription or license), as well as other parameters.

In scenarios where the user is relatively new to an application or a suite of applications, the recommendations generated by the foundation model service may provide the user with a roadmap or range of options for accomplishing the user's particular intention. Moreover, the technology disclosed herein facilitates the user's ability to perform a task within the associated application by transmitting background or contextual information relating to the task and the user's level of proficiency to an AI engine of the application. By transmitting background or contextual information to the AI engine of the application, the receiving AI engine can provide further guidance to the user at the appropriate level of instruction. For example, if the user wishes to create a household budget and the user has relatively limited experience using spreadsheets, the AI engine of the application service may indicate to an AI engine of a spreadsheet application to display a budget template or to present instructions for creating a simple budget in relatively few steps using relatively simple spreadsheet functions. In contrast, for a highly experienced user, the AI engine may indicate to the AI engine of the application that advanced spreadsheet tools or functionalities (e.g., pivot tables or look-up tables) would be appropriate for the user.

The targeted portion of the prompt generated by the AI engine includes one or more applications or application functionalities identified by the AI engine as relating to the user input. For example, a software developer may submit a query relating to processing an image to extract text from the image. The AI engine may identify and include in the targeted portion one or more software plugins with the necessary coding operations for performing the job or for performing tasks related to the job, such as changing the file format, filtering operations, etc.

In an implementation, the prompt generated by the application service tasks the foundation model with generating its output in a parse-able format. Upon receiving the output, the application service configures its display based on the output. For example, the output may be configured in extensible Markup Language (XML) tags for display. In other scenarios, the output may be configured in a JavaScript Object Notation (JSON) data object or other data structure. In still other scenarios, the output may be configured as source code to be executed by the application service or by a recommended application.

Foundation models of the technology disclosed herein include large-scale generative artificial intelligence (AI) models trained on massive quantities of diverse, unlabeled data using self-supervised, semi-supervised, or unsupervised learning techniques. Foundation models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. In some scenarios, a foundation model may be fine-tuned for specific downstream tasks. Foundation models include BERT (Bidirectional Encoder Representations from Transformers) and ResNet (Residual Neural Network). Foundation models may be multimodal or unimodal depending on the modality or modalities of the inputs (discussed infra). Types of foundation models may be broadly classified as or include pre-trained models, base models, and knowledge models, depending on the particular characteristics or usage of the model.

Multimodal models are a class of foundation model which leverages the pre-trained knowledge and representation abilities of foundation models to extend their capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image, for example, by using an image encoder to extract visual features, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video—generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of sophisticated language understanding and generation capabilities due to their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are novel, open-ended, and unpredictable.

Technical effects which may be appreciated from the technology disclosed herein include reducing the number of prompt-reply cycles to generate relevant, personalized content by the LLM service for a user. By leveraging a fine-tuned AI engine for generating a portion of the prompt, the foundation model service can generate output that is personalized for the user based on information available to the application service, such as the user's level of proficiency, usage history, subscription level, and so on. In addition, the AI engine is trained to optimize the targeted portion with respect to improving the user experience and with respect to business considerations, such as user retention, user conversion (e.g., from a trial to a paid subscription), or upselling. For example, the AI engine may be trained on proprietary sales data relating to application usage and free-trial offers. By using an AI engine to generate recommendations according to its training protects the proprietary information from exposure while providing the foundation model service with an enriched context for generating a reply. Further, in using an AI engine to generate the targeted portion of the prompt, the privacy of the data associated with the user is also protected in that the AI engine generates a summary of the information tailored for presentation to the foundation model service based on a determination of the AI engine on which aspects of the user data are most relevant.

Further, in a streamlined interaction with the foundation model, the application service configures the prompt to include the relevant, user-specific contextual information. The application service tailors its prompts to cause the foundation model to generate a reply with minimal latency to minimize negative impacts to the user experience and costs to productivity, for example, by selectively including content context datastore. The application service may also tailor the prompts to more fully leverage the creativity of the foundation model while reducing the probability that the foundation model will digress or hallucinate (i.e., refer to or imagine things that do not actually exist) which can frustrate the user or further impair productivity.

Other technical advantages may be appreciated from the disclosed technology. Prompts tailored according to the disclosed technology reduce the amount of data traffic between the application service and the foundation model for generating useful information for the user. For example, the disclosed technology streamlines the interaction between the user and the application service by keeping the foundation model on task and reducing the incidence of erroneous, inappropriate, or off-target replies. The prompts are also tailored to task the foundation model with generating parse-able output, thereby reducing the need for post-processing the replies to render the content in a useful form, such as for display in a user interface as a graphical user input device. The disclosed technology also promotes more rapid convergence, that is, reducing the number of interactions with the foundation model to generate a desired result.

In addition, the disclosed technology focuses the generative activity of the foundation model to improve the performance of the foundation model without overwhelming the foundation model (e.g., by exceeding the token limit). For example, the disclosed technology balances prompt size (e.g., the number of tokens in the prompt which must be processed by the foundation model) with providing sufficient information to generate a useful response. Using an AI engine to generate a targeted portion of the prompt optimizes the amount and type of information that goes into the prompt, further reducing the impact on the token limit. The net of streamlined interaction, more rapid convergence, and optimized prompt sizing is reduced data traffic, faster performance by the foundation model, reduced latency, and concomitant improvements to productivity costs and to the user experience.

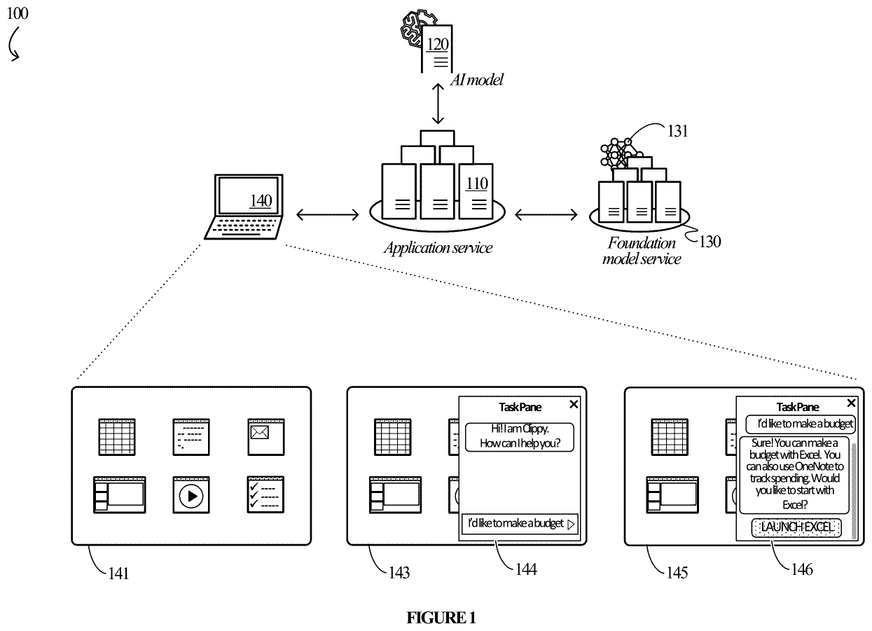

Turning now to the Figures, FIG. 1 illustrates operational environment 100 in an implementation. Operational environment 100 includes application service 110, foundation model service 130, and computing device 140. Application service 110 hosts an application to endpoints such as computing device 140. Computing device 140 executes applications locally that provide a local user experience and that interface with application service 110. The applications running locally with respect to computing device 140 may be natively installed and executed applications, browser-based applications, mobile applications, streamed applications, or any other type of application capable of interfacing with application service 110 and providing a user experience, such as user experiences 141, 143, and 145 displayed on computing device 140. Applications of application service 110 may execute in a stand-alone manner, within the context of another application such as a presentation application or word processing application, with a spreadsheet functionality, or in some other manner entirely.

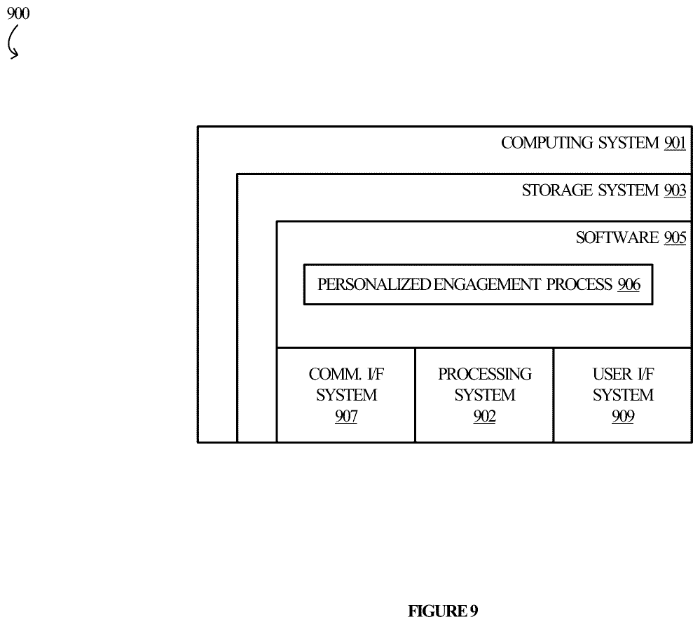

Computing device 140 is representative of a computing device, such as a laptop or desktop computer, or mobile computing device, such as a tablet computer or cellular phone, of which computing device 901 in FIG. 9 is broadly representative. Computing device 140 communicates with application service 110 via one or more internets and intranets, the Internet, wired or wireless networks, local area networks (LANs), wide area networks (WANs), and any other type of network or combination thereof. A user interacts with an application of application service 110 via a user interface of the application displayed on computing device 140. User experience 141, 143, and 145 displayed on computing device 140 including task panes 144 and 146, is representative of a user experience of an application environment of an application hosted by application service 110 in an implementation.

Application service 110 is representative of one or more computing services capable of hosting an application and interfacing with computing device 140 and with foundation model service 130. Application service 110 employs one or more server computers co-located or distributed across one or more data centers connected to computing device 140. Examples of such servers include web servers, application servers, virtual or physical (bare metal) servers, or any combination or variation thereof, of which computing device 901 in FIG. 9 is broadly representative. Application service 110 may communicate with computing device 140 via one or more internets, intranets, the Internet, wired and wireless networks, local area networks (LANs), wide area networks (WANs), and any other type of network or combination thereof. Examples of services or sub-services of application service 110 include—but are not limited to—voice and video conferencing services, collaboration services, file storage services, and other application services. In some examples, application service 110 may provide a suite of applications and services with respect to a variety of computing workloads such as office productivity tasks, email, chat, voice and video, and so on.

AI model 120 is executed by or in association with application service 110. AI model 120 is representative of an AI or machine learning model which generates recommendations for users based on user skill level, application frequency of use, subscription level and is trained on data relating to user skill level, application frequency of use, subscription level, and conversion activity (e.g., starting a new subscription or upgrading a subscription). AI model 120 may also classify users on the basis of the user's purpose, i.e., whether the user is accessing an application primarily for business, home, or education purposes. The skill level of a user may be inferred by AI model 120 based on metrics such as the user's frequency of using the application, the user's subscription level, the user's usage of various functionalities of an application, the user's purpose, and so on. For example, for a spreadsheet application, a user with a relatively low level of usage including only basic cell functions, a classification layer of AI model 120 may classify the user as a novice. In contrast, a user with a high level of usage including advanced functionalities such as data tables, chart generation, pivot-tables, look-up functions, data analysis tools, conditional formatting, and the like may be classified by the classification layer as an advanced user. AI model 120 may also predict the likelihood of upselling the user to a particular license or SKU (stock keeping unit). For example, AI model 120 may predict the likelihood of upselling a “Freemium” customer (i.e., a customer who is provided basic product or service for free but who is charged for add-ons) to an add-on tool or service. AI model 120 may also determine whether the user is eligible for special offers, such as limited time offers targeting a particular subset of users, subscribers, licensees, etc.

Foundation model service 130 is representative of one or more computing services capable of hosting an LLM computing architecture and communicating with application service 110. Foundation model service 130 may be implemented in the context of one or more server computers co-located or distributed across one or more data centers. Foundation model service 130 hosts foundation model 131 which is representative of a deep learning AI model, such as BERT, ERNIE, T5, XLNet, or of a generative pretrained transformer (GPT) computing architecture, such as GPT-3®, GPT-3.5, ChatGPT®, or GPT-4.

In an exemplary operational scenario of an implementation of operational environment 100, a user of computing device 140 interacts with application service 110 via a user interface displaying a user experience of which user experiences 141, 143, and 145 are representative. User experience 141 includes an application environment of application service 110. As illustrated in user experiences 141, 143, and 145, the application environment displays icons representing a suite of applications such as a suite of productivity applications. The suite of productivity applications may include applications such as a word processing application, a spreadsheet application, a presentation application, a collaborative application, an email application, a notetaking or checklist application, an illustration application, and so on.

Continuing the exemplary scenario of operational environment 100, application service 110 displays task pane 144 in user experience 143. Within task pane 144, application service 110 poses a query to the user to obtain a user input regarding the user's particular goal or interest. Application service 110 receives the user input indicating a job or task that the user wishes to perform using one or more of the displayed applications.

In task pane 144 of user experience 143, the user enters a job that the user would like to accomplish-making a budget. The user may key in the entry in the user interface or may verbally state the request, which is received by computing device 140 via a microphone and which is rendered to text via a speech-to-text engine. Based on the user input, application service 110 generates a prompt for foundation model service 130 to provide recommendations relating to the job. To generate the prompt, application service 110 receives from AI model 120 enriched context information which is incorporated into the prompt. Application service 110 also includes, in the prompt background, global information such as rules governing how foundation model 131 is to generate its response. In some scenarios, the rules also specify how foundation model 131 is to format its output, such as generating its output in a parse-able format by which application service 110 can extract and serve the reply to the user interface on computing device 140.

The enriched context generated by AI model 120 may include information relating to the user's familiarity or skill level with various applications of the application suite. AI model 120 may receive from a context source, such as a user subscription datastore, information relating to the user's subscription plan, if any. For example, the subscription datastore may indicate the user has a basic subscription plan with access to a basic or more limited set of functionalities and that the user's subscription began within the last six months. AI model 120 may also receive information relating to the user's activity with various applications, including the frequency of use and types of tools used. For example, AI model 120 may receive data from an access history indicating that the user has only accessed the spreadsheet application of the application suite less than five times in the preceding six months.

Upon receiving a response from foundation model service 130, application service 110 configures a display of the content of the response for display in task pane 146 of user experience 145. In task pane 146, the response is displayed in the context of a turn-based chat with the user input. The recommendation provided by foundation model service 130 includes a recommended application (Microsoft Excel®) for the task of making a budget. Application service 110 also displays in task pane 146 a graphical button by which the user can launch the recommended application. The graphical button is generated for display by application service 110 based on the response from foundation model service 130, which is in turn based on contextual information provided in the prompt. The contextual information includes one or more recommendations to be made by foundation model service 130 contingent on user-specific information provided to foundation model service 130 as part of the enriched context.

To continue the exemplary operational scenario, should the user elect to launch the recommended application, application service 110 relays to an application-specific AI engine (not shown) information relating to the user's request, such as a template for creating a budget identified as appropriate to the request by AI model 120. Application service 110 may also relay information to the application-specific AI engine which relates to how the user should be guided to complete the job of creating a budget. AI model 120 may infer a user profile based on metrics such as application usage data, user's purpose, subscription status, and so on, and include the user profile in the targeted portion of the prompt. AI model 120 may instruct the application-specific AI engine to generate instructions for the user according to the user's skill level or user profile. For example, if AI model 120 detects the user is relative novice with respect to the spreadsheet application (based on limited usage, for example), AI model 120 may identify a budget template and instruct the application-specific AI engine to walk the user through a simple set of steps for using the template. AI model 120 may identify the budget template based on data relating to its popularity amongst users with similar usage data or a similar user profile. For a more advanced user seeking to create a budget, the output generated by AI model 120 and sent to the application-specific AI engine may specify advanced functionalities, such as look-up tables or pivot tables. In some scenarios, AI model 120 may select or identify an application from amongst multiple applications based on the user's familiarity with the application. For example, if the user is more proficient in or more frequently uses a database application than a spreadsheet application, AI model 120 may identify the database application in the targeted portion.

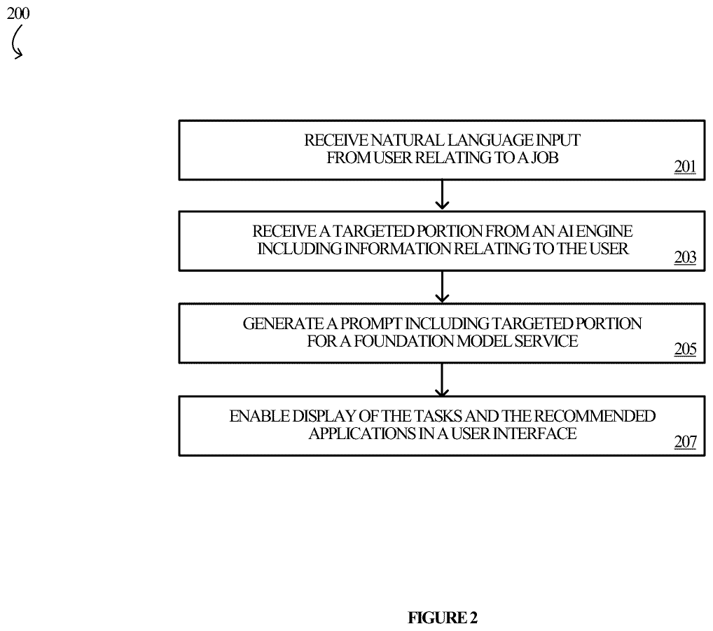

FIG. 2 illustrates a method of operating a foundation model integration for customer engagement or onboarding with respect to an application service in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

A computing device receives a natural language input from a user relating to a job to be performed by one or more applications (step 201). In an implementation, the input may be received from the user in a web browser or application environment. The user may be contemplating the purchase of a software license for one or more applications, or the user may be executing an application on his or her computing device and seeking assistance within the application environment. The user may key in the natural language query in the user interface of the application or may state a query into an audio input device of the computing device which is rendered by a speech-to-text engine to text input in the graphical interface.

The computing device receives a targeted portion for a prompt from an AI engine which includes information relating to the user with respect to the one or more applications (step 203). In an implementation, the targeted portion includes enriched contextual information based on user-specific information received by the AI engine. Including the targeted portion in the prompt serves to target the output of the foundation model service according to the user-specific information and the context of what can be performed by the user using the application or suite of applications according to the user's skill level. The enriched contextual information may be a natural language summary including: what is known about the user with respect to the application of the application environment or to a suite of applications; what the application or suite of applications can do (e.g., tools or functionalities); and what business considerations may be included by the foundation model service in generating its recommendation; and what the user wants to do (e.g., the job the user wants to perform).

In an implementation, the AI engine identifies specific tools or functionalities of the application or suite of applications relating to the job the user wishes to perform. In generating the targeted portion, the AI engine may include a selection of applications and functionalities of those applications which constrain the domain of options of the foundation model service in generating its recommendations. Thus, the foundation model service is prevented from generating recommendations which are outside the capabilities of the application or suite of applications. The business considerations included by the AI engine in the targeted portion can include a set of actions or offers from which the foundation model service can select according to the user-specific information, such as describing a new application feature relating to the user's job, an offer to upgrade the user's subscription plan, or other specific action that leads to higher customer retention, such as an offer to extend a free-trial for an additional month. The business considerations may be based on proprietary sales or marketing data relating to customer engagement and factors in successful onboarding.

Next, the computing device generates a prompt for the foundation model service including the targeted portion generated by the AI engine, and tasks the foundation model service with recommending applications associated with each task (step 205). In an implementation, the computing device generates a prompt including the targeted portion and a global portion which is universal to prompts submitted to the foundation model service for generating recommendations relating to a job or goal which a user wishes to accomplish. The global portion may specify the particular content the foundation model service is to generate, assign a persona to the foundation model service, specify the format of the output, and provide examples of the types of output that is expected. Together with the targeted portion, the prompt allows the foundation model to be creative in generating recommendations for the user but constrains the foundation model service to generate a response that is within the domain of the application or suite of applications and tailored to the proficiency and access of the user.

Upon receiving a response to the prompt from the foundation model service, the computing device enables display of the tasks and recommended applications in a user interface of the computing device (step 207). In an implementation, the computing device receives the output formatted according to formatting rules provided in the prompt and extracts one or more tasks and recommended applications for completing each task. For example, where the user input relates to creating a Christmas card, the foundation model service may identify a number of tasks including creating the card using a card template or layout of a word processing application, generating imagery for the card using an illustration application, assembling a mailing list in a spreadsheet application according to the user's contacts in a contacts application, creating a calendar event for purchasing postage stamps in a calendar application, and so on. The computing device may display the output in the user interface, such as in a chat pane of the user interface where the user input was received and may also generate graphical buttons to display in association with the configured output by which the user can launch a recommended application, purchase a subscription for the application, or start a free trial of the application.

Subsequent to displaying the configured output from the foundation model service, the user may elect to move forward with a recommended application, such as by clicking a graphical button to launch a recommended application. In an implementation, when user launches a recommended application, the computing device sends to an AI engine of the application contextual information relating to the user's job, such as the task to be completed, the user's skill level, and any recommended designs or templates relating to the job. Referring to the previous example, if the user elects to open the word processing application to create the card, the computing device may send to an AI engine of the application information relating to the recommended card template, the user's skill level, and the user's query. The AI engine of the application may display an interface when the application is launched which immediately acknowledges the user's query and offers information (e.g., steps, instructions, help articles) relating to the user's query. The interface may also prompt or query the user with regard to the user's website so that content can be scraped and analyzed by the AI engine to determine tasks for the application to accomplish the user's job and templates the application or an application assistance engine (in some scenarios referred to as a “copilot”) should create.

Referring once again to FIG. 1, operational environment 100 includes a brief example of process 200 as employed by elements of operational environment 100 in an implementation. Computing device 140 displays an application environment where a user submits a natural language input relating to accomplishing a job using one or more software applications. Application service 110 receives the user input from computing device 140.

Application service 110 receives a targeted portion from AI model 120 including enriched context for the prompt. In an implementation, AI model 120 generates natural language text for the targeted portion based on user-specific information from one or more context datastores of application service 110. AI model 120 also specifies in the targeted portion an application scope regarding functionalities of one or more applications as they relate to the user input. AI model 120 may also include in the targeted portion actions or offers foundation model service 130 can recommend if/when foundation model service 130 deems appropriate according to the user-specific information. In some implementations, AI model 120 may include the user input verbatim, or AI model 120 may include an interpretation of the user input generated by AI model 120 which summarizes the substance of the input for clarity.

Application service 110 generates a prompt for foundation model service 130 including the targeted portion received from AI model 120. In an implementation, application service 110 selects a prompt template for generating recommendations by foundation model service 130 based on user input and a domain of application functionalities which may be applicable to the user input. The selected prompt template includes a global background portion of rules and examples which govern how foundation model 131 generates its output. For example, the global background portion may specify the content that foundation model 131 is to generate in response to the prompt but also content which foundation model 131 should not generate. The global background portion may also specify a particular output format by which application service 110 can extract the relevant content. The global background portion may also include examples of desirable output in terms of content, structure, style, length, and format. The prompt template may also include a field in which application service 110 inserts the targeted portion generated by AI model 120.

Application service 110 submits the prompt to foundation model service 130, such as through an application programming interface (API) hosted by foundation model service 130. Upon receiving a reply to the prompt from foundation model service 130, application service 110 configures a display of the content of the reply for display in the user interface on computing device 140. To configure a display, in an implementation, application service 110 extracts the content according to the format specified in the prompt. For example, foundation model service 130 may be tasked with enclosing individual recommendations in semantic tags defined in the prompt (e.g., <rec> and </rec>, etc.) or in an element of a data array or JSON object.

The output from foundation model service 130 may also recommend actions or offers to be presented to the user, which may be enclosed in appropriately defined semantic tags (e.g., <offer> and </offer>, <action> and </action>, etc.). For example, if the output includes a recommendation for a particular application to which the user is a subscriber, application service 110 may configure a graphical button for launching the application from the user interface. If the output instead includes a recommendation for a subscription to an application or a suite of applications based on the user not being a current subscriber, application service 110 may configure a graphical button which redirects the interface to a webpage for purchasing a license or starting a free trial of the recommended application or suite of applications.

In various implementations, when application service 110 configures and sends the output for display in the user interface on computing device 140, application service 110 may receive user input via the user interface electing to launch a recommended application. When application service 110 launches the recommended application, an AI engine of the application receives contextual information from application service 110 relating to the user input, recommendations generated by foundation model service 130 relating to using the recommended application for the specified task, and information relating to skill level or application usage of the user. The AI engine of the application may present in the application environment information relating to accomplishing the task using the relevant functionality and according to the skill level of the user.

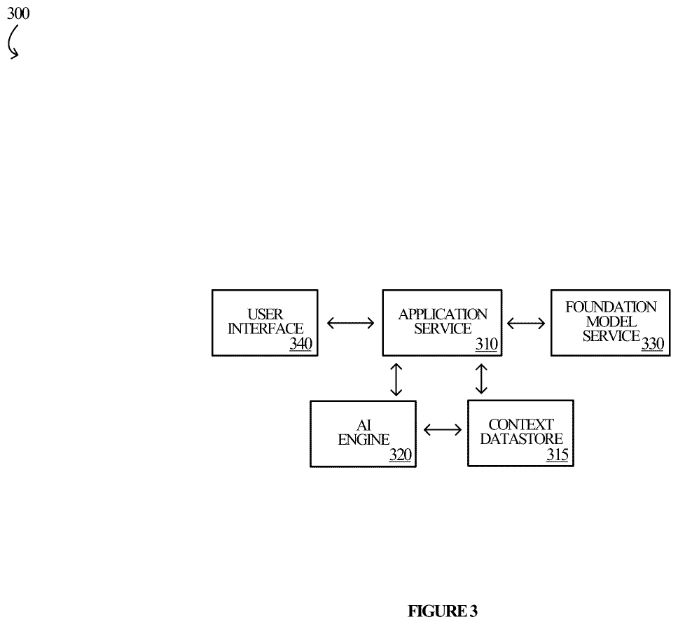

FIG. 3 illustrates systems architecture 300 for a foundation model integration for customer engagement and onboarding with respect to an application service in an implementation. Systems architecture 300 includes application service 310, context datastore 315, AI engine 320, foundation model service 330, and user interface 340.

Application service 310, of which application service 110 is representative, includes one or more computing services capable of hosting an application and interfacing with a computing device hosting user interface 340 and with foundation model service 330. AI engine 320, of which AI model 120 is representative, is operatively coupled to application service 310 and is representative of a fine-tuned AI engine for generating enriched context based on user data and context information received from application service 310. Context datastore 315 is representative of one or more data repositories operatively coupled to application service 310 for storing data, such as data relating to user subscription plans and user access to application service 310. Context datastore 315 may also include a repository for communication with foundation model service 330, such as the prompts sent and replies received from foundation model service 330 in a session or conversation. In some implementations, AI engine 320 and/or context datastore 315 are subservices of application service 310. Communications between AI engine 320 and context datastore 315 may be relayed by application service 310 or, in some scenarios, AI engine 320 may communicate directly with context datastore 315.

User interface 340 is displayed on a user computing device, such as computing device 140 of FIG. 1. User interface 340 displays an application environment which receives user input (e.g., keyed in or verbal input) and displays responses configured based on replies from LLM service 330. The application environment displayed in user interface 340 may be hosted natively by the software application executing on the computing device or it may be hosted in a web browser.

Foundation model service 330, similar to foundation model service 130, is representative of a service hosting a deep learning AI model, such as BERT, ERNIE, T5, XLNet, or of a generative pretrained transformer (GPT) computing architecture such as GPT-3®, GPT-3.5, ChatGPT®, or GPT-4.

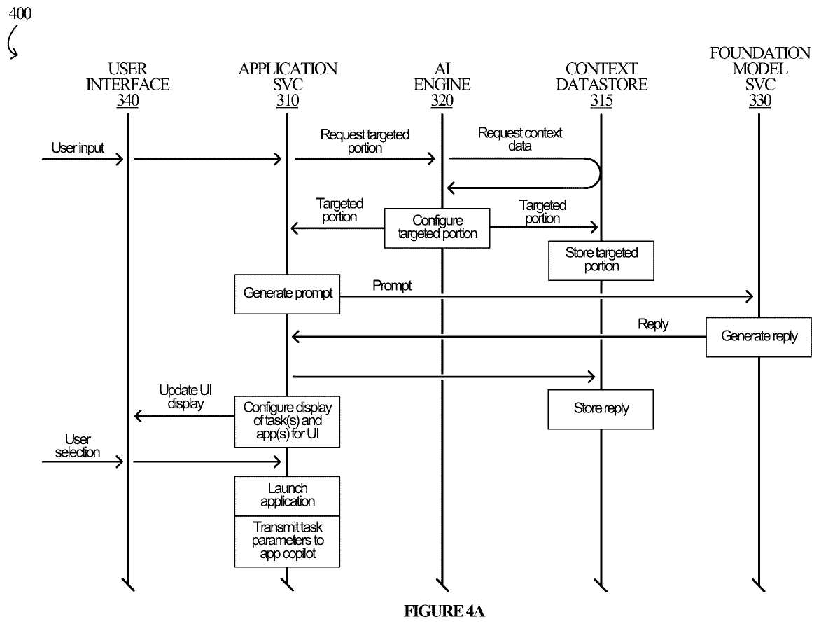

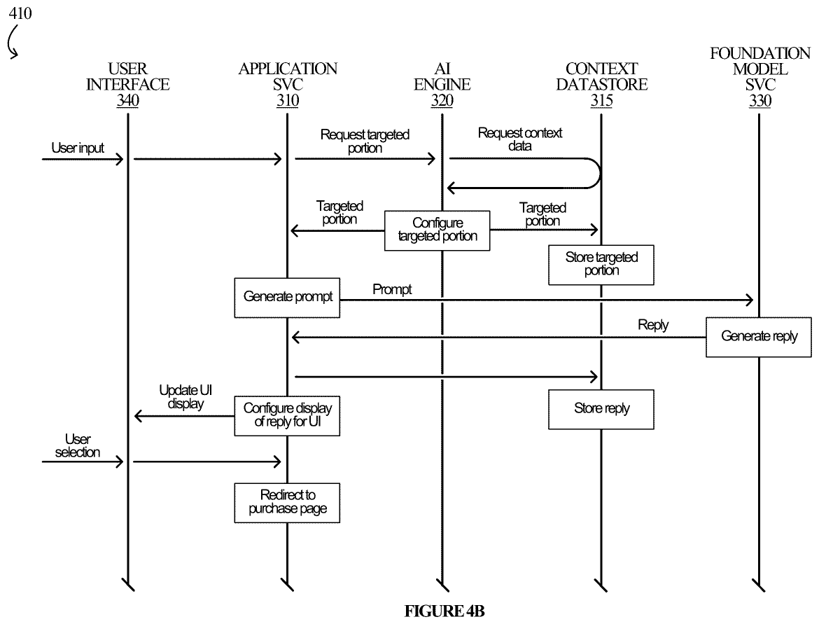

Turning now to FIG. 4, FIG. 4 illustrates operational scenario 400 of a foundation model integration for customer engagement with respect to an application service referring to elements of systems architecture 300 in an implementation. Operational scenario 400 illustrates a scenario of generating one or more recommendations for a user relating to performing a job or accomplishing a goal in the context of one or more software applications and receiving user input subsequent to receiving the one or more recommendations. For the purpose of illustration, it is assumed that the user has access to one or more software applications of the application service. For example, the user may be accessing the applications on a trial basis, or the user may be a subscriber to the applications of application service 310.

In operational scenario 400, user interface 340 receives user input including a spoken or keyed-in natural language input relating to performing a job or accomplishing a task. The user input may be received in a chat interface or task pane displayed in user interface 340. Application service 310 receives the user input and requests a targeted portion from AI engine 320. The targeted portion is to be included in a prompt to be sent to foundation model service 330.

Upon receiving the request for the targeted portion, AI engine 320 requests and receives context data from context datastore 315 via application service 310. Context data can include user-specific usage metrics and information relating to the user's subscription level. Context data can also include data relating to business considerations, such as aspects of the one or more software applications which are to be prioritized in providing recommendations to users. AI engine 320 receives context data from context datastore 315 and configures a targeted portion for the prompt. The targeted portion may be natural language text which provides foundation model service 330 with the enriched context for generating a response to the user input. The enriched context provided in the targeted portion limits the scope the response by foundation model service 330 to a domain specific to the available applications and tailors the response to the user-specific information (e.g., user profile). AI engine 320 sends the targeted portion to application service 310 for inclusion in the prompt. AI engine 320 may also send the targeted portion to context datastore 315 for use in subsequent prompts as additional context.

Application service 310 configures the prompt including the targeted portion generated by AI engine 320. In some implementations, the prompt is configured according to a prompt template which includes a global portion of rules which govern how foundation model service 330 is to generate its output and with examples which reflect the desired output. Application service 310 submits the prompt to foundation model service 330. foundation model service 330 generates a reply to the prompt and returns the reply to application service 310.

Application service 310 receives the reply and extracts the relevant content from the reply for display in user interface 340. For example, application service 310 may configure the natural language output from foundation model service 330 for display in a turn-based chat pane. In some implementations, the configured output includes a set or series of tasks relating to the user's job or goal along with a recommended application for accomplishing each of the tasks. In parsing the output for display, application service 310 may configure and display a graphical button for launching a recommended application. Application service 310 also sends the reply to context datastore 315 for use in subsequent prompts as additional context.

Continuing operational scenario 400, user interface 340 receives a selection by the user indicating the user would like to launch or open the recommended application. For example, the user may click a graphical button presented in the chat pane for launching the application. Application service 310 receives the user input and launches the application. In some implementations, when the application is launched, application service 310 also sends information relating to the user request to an AI engine or an application assistance engine (in some scenarios referred to as a “copilot”) of the application along with the recommendation generated by foundation model service 330, such as a recommended in-app template and/or information relating to the skill level or subscriber level of the user. Based on the information provided by application service 310, the application copilot may open the recommended template and/or display in a chat interface or task pane of the application environment messages relating to the user input, such as instructions for how to accomplish it.

Operational scenario 410 of FIG. 4B begins in a similar fashion as operational scenario 400, however, for the purpose of illustration it is now assumed that the user is prospective customer who does not have a software license for applications supported by application service 310. When application service 310 configures and displays output from foundation model service 330 in user interface 340, the output indicates that, based on the enriched context and prompt instructions, the user should be presented with the option of trial access (e.g., free 30-day trial access) to the relevant application or application suite. Application service 310 in parsing the output configures a graphical button which, when selected by the user, redirects user interface 340 to a webpage for registering for the trial access. Application service 310 receives an indication of the user selection from user interface 340 and performs the redirect. When the user completes the registration, application service 310 launches the recommended application and provides to a copilot of the application information relating to accomplishing the user's job or goal by which the copilot can provide information and assistance tailored to the user and to the user's request.

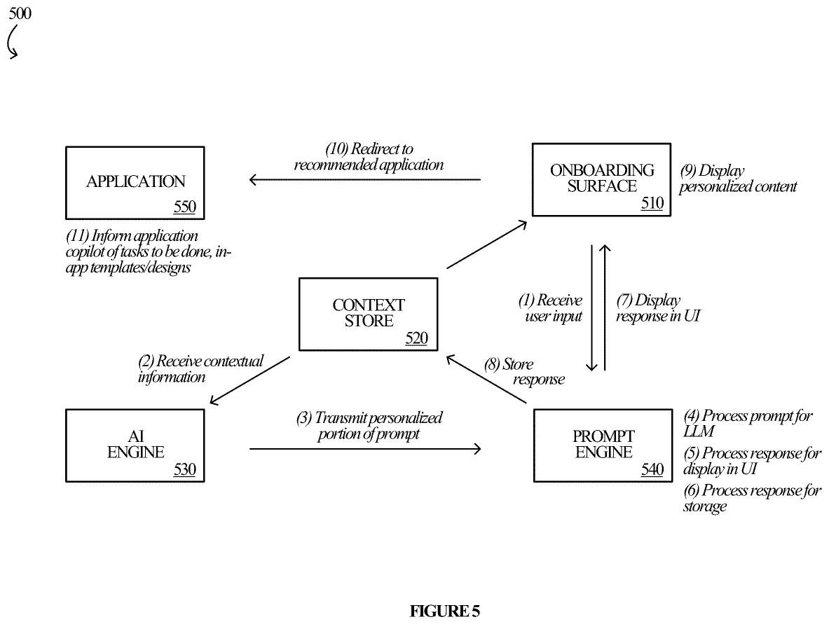

FIG. 5 illustrates an operational scenario 500 of an LLM-type foundation model integration for customer engagement with an application service carried out by elements of a systems architecture, such as elements of an application service, in an implementation. In operational scenario 500, onboarding surface 510 may be an application environment of an application service hosting application 550, such as a webpage for purchasing a license for the application service or an educational or support website which helps customers, such as Freemium, current, or prospective customers, find value in their subscriptions. Onboarding surface 510 receives user input, such as a request for information about how to perform a task. Onboarding surface 510 sends the user input to prompt engine 540 of the application service to configure a prompt for an LLM service (not shown).

As or in coordination with prompt engine 540 receiving the user input, AI engine 530 of the application service receives contextual information from one or more datastores of context store 520. Based on the contextual information, AI engine 530 generates a targeted portion for the prompt to be sent to the LLM service. The targeted portion includes enriched context for the prompt: information which causes or allows the LLM service to target its recommendations according to the particular needs and abilities of the user and according to the applications and functionalities available to the user (e.g., according to the user's subscription plan). Thus, the LLM service is able to creatively devise tasks related to accomplishing the user's request, but those tasks are constrained to a domain of options available according to the user's ability and to the available functionalities.

Prompt engine 540 configures the prompt including the targeted portion received from AI engine 530 and transmits the prompt to the LLM service via an API hosted by the LLM service or other means. Upon receiving a reply to the prompt from the LLM service, prompt engine 540 processes the reply for display in onboarding surface 510 and also for storage in context store 520. In configuring the reply for display, prompt engine 540 may configure a graphical button by which the user can cause the application service to launch application 550. The graphical button may also cause the application service to launch an assistive component or copilot of application 550 within the context of application 550, such as an application-specific AI engine, and/or to populate a document of application 550 with a personalized template. The reply is also stored in context store 520 for use in subsequent prompts or a prompt chain to provide additional context for the LLM service in generating its output.

When the configured display is transmitted to onboarding surface 510, the user is presented with one or more recommendations responsive to the user input which can be accomplished by application 550. The user is also presented with the graphical button configured for launching application 550. When the user elects to launch application 550, application 550 receives information relating to the user input or job to be done and to the reply from the LLM service, such as the recommendations for completing the job. For example, if the LLM service recommends a design template of application 550, application 550 may display the design template in the application environment. In some implementations, prompt engine 540 or another component of the application service transmits the information relating to the job to be done and the LLM response to the assistive component of application 550 via an API.

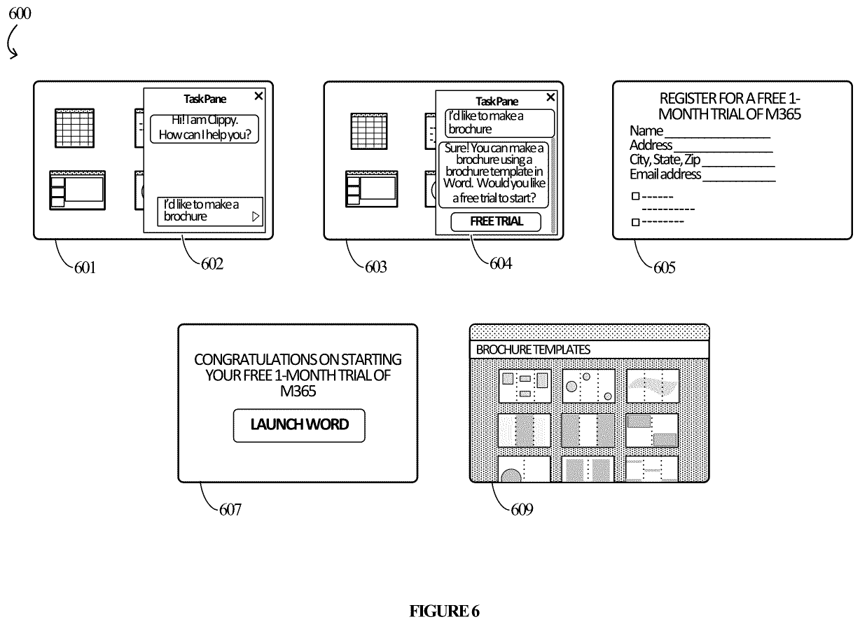

FIG. 6 illustrates operational scenario 600 of user onboarding via a foundation model integration, such as an LLM integration, of an application service in an implementation. Operational scenario 600 includes a sequence of user experiences when a user, a prospective customer, enters a query relating to completing a job using an application of the application service (e.g., M365 service), such as in a webpage of the application service.

In user experience 601, task pane 602 is surfaced by the application service which asks the user to enter a question. The user enters input in task pane 602 inquiring about making a brochure. In response to the input, the application configures and submits a prompt to a foundation model service to generate a recommended response or recommendation for the user. In configuring the prompt, the application service receives prompt language from an AI engine based on user-specific data, application functionalities which are available to the user, and offers that the LLM service can include in its recommendation as it deems appropriate.

On the basis of the prompt, the foundation model service generates a response, elements of which are displayed by the application service in task pane 604 of user experience 603. The response includes a natural language component including an application recommendation and an offer for a free trial for the user. The application service configures a graphical button by which the user can follow through on the suggestion based on the response.

When the user clicks the “Free Trial” button, the browser is redirected by the application service to a registration page (illustrated in user experience 605) by which the user can register for the free trial. Upon successful registration for the free trial, the application service redirects the browser to a landing page (illustrated in user experience 607) where the user can launch the recommended application.

When the application service receives an indication from the user interface that the user wishes to launch the recommended application, the application is launched, as illustrated in user experience 609. In launching the application, the application service also directs an assistive component of the application to display information relating to the user input, the reply from the foundation model service, and information relating to the user's skill level. In user experience 609, the application environment of the application displays in-app templates for brochures from which the user can select a template to complete his or her job. In some scenarios, when the application is launched, the user may be presented with a document or template with personalized content, such as a template incorporating information scraped from the user's website or provided in the prompt, along with an informed in-app copilot or assistive component to help the user with editing the content provided in the template to complete the specified task.

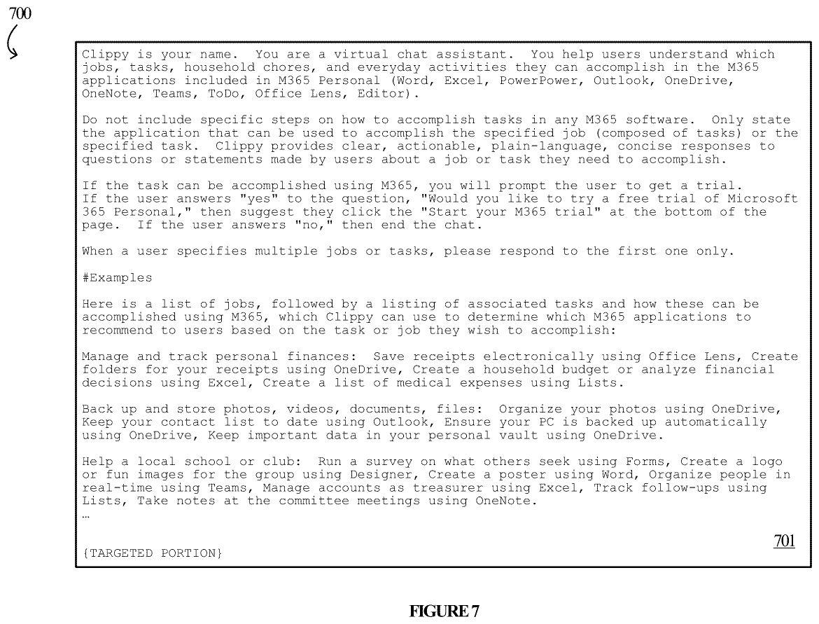

FIG. 7 illustrates prompt template 701 for configuring a prompt for a foundation model service, such as an LLM service, based on a user query relating to an application service. Prompt template 701 includes a global portion which is generally applicable to a particular class of prompts without modification. In an implementation, the global portion identifies a persona for the foundation model and instructs the foundation model as to the output it is to generate. Prompt template 701 also includes a number of output examples representative of the type of output the foundation model is to generate. Prompt template 701 also includes a field for the application service to insert a targeted portion generated by an AI engine. The targeted portion includes the user input, user-specific information, application functionalities which are available to the user as determined by the AI engine, and offers or actions which the foundation model can recommend as it deems appropriate. The set of functionalities may be determined by the AI engine based on the user's subscription level (or lack of subscription), as well usage metrics relating to the user's skill level or familiarity with the application.

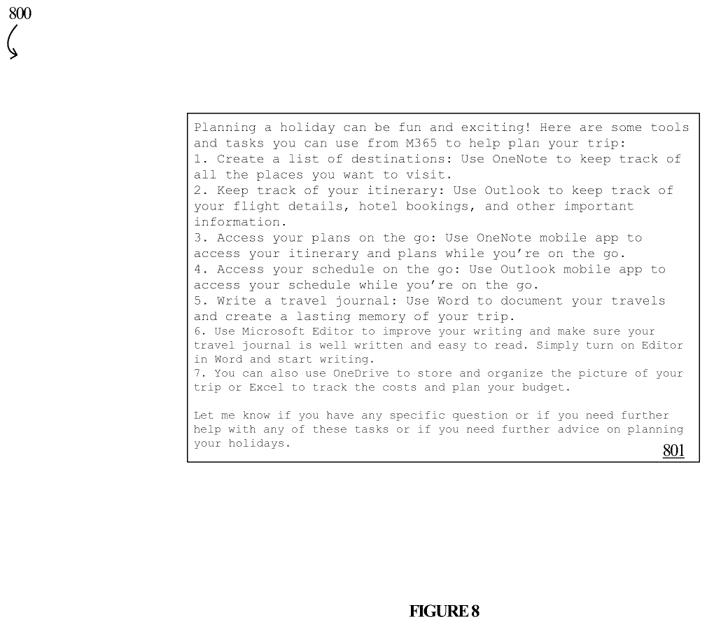

FIG. 8 illustrates configured output 801 based on a reply from an LLM-type foundation model service. In configured output 801, the LLM service has generated seven recommendations for a user based on a user query about “going on holiday.” The LLM service generates the recommendations according to an instruction in the prompt to identify tasks associated with the user's job or goal, and to recommend an application of the application service for performing the task. As illustrated, the fifth task identified by the LLM relating to “going on holidays” is “Write a travel journal.” To accomplish this task, the LLM recommends the (Microsoft) Word application. The prompt tasking the LLM service with generating the recommendations is based on a prompt template, such as prompt template 701, and including the user input.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements personalized engagement process 906, which is (are) representative of the personalized engagement processes discussed with respect to the preceding Figures, such as process 200. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and non-volatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including personalized engagement process 906) may be implemented in program instructions and among other functions may, when executed by processing system 902, direct processing system 902 to operate as described with respect to the various operational scenarios, sequences, and processes illustrated herein. For example, software 905 may include program instructions for implementing a personalized engagement process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support personalized engagement processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

The following provides additional exemplary implementations of the contents disclosed herein. The exemplary implementations include a method of operation according to the steps listed below (Examples 1 through 9). The exemplary implementations also include a computing apparatus including one or more computer readable storage media, one or more processors operatively coupled with the one or more computer readable storage media, and program instructions stored on the one or more computer readable storage media which, when executed by the one or more processors, direct the computing apparatus to perform at least the steps listed below. The exemplary implementations also include one or more computer-readable non-transitory storage media having program instructions stored thereon that, when executed by one or more processors operatively coupled with the one or more computer-readable storage media, direct a computing device to operate according to the steps listed below. The steps include:

Example 1: receive natural language input from a user relating to a job, wherein the job is to be performed by one or more applications; receive, from an artificial intelligence (AI) engine, a targeted portion generated by the AI engine, wherein the targeted portion includes information relating to the user with respect to the one or more applications; generate a prompt with which to elicit a reply from a foundation model service, wherein the prompt includes a global portion and the targeted portion and wherein the prompt tasks the foundation model service with identifying one or more tasks relating to the job and identifying a recommended application in association with each task, wherein the recommended application is an application of the one or more applications recommended by the foundation model service for accomplishing the associated task; and enable display of the one or more tasks and the one or more recommended applications from the foundation model service in a user interface.

Example 2: Example 1, wherein the information relating to the user includes a skill level of the user with respect to the one or more applications.

Example 3: Any combination of Examples 1 through 2, wherein the targeted portion includes information relating to a subscription status of the user.

Example 4: Any combination of Examples 1 through 3, wherein the targeted portion includes one or more recommendations, wherein each of the one or more recommendations relates to an offer to be made to the user with respect to the subscription status of the user, and wherein the prompt tasks the foundation model service with identifying a recommendation of the one or more recommendations relating to the application.

Example 5: Any combination of Examples 1 through 4, wherein the targeted portion includes functionalities of each of the one or more applications relating to the job.

Example 6: Any combination of Examples 1 through 5, wherein the program instructions direct the computing apparatus to send, to a recommended application of the one or more recommended applications, information relating to the associated task.

Example 7: Any combination of Examples 1 through 6, wherein the information relating to the task includes a template.

Example 8: Any combination of Examples 1 through 7, wherein the global portion comprises examples, wherein each of the examples includes an example job, one or more example tasks of the example job, and an application of the one or more applications associated with each of the one or more example tasks.

Example 9: Any combination of Examples 1 through 8, wherein the foundation model service comprises an LLM service.

What is claimed is:

1. A computing apparatus comprising:
one or more computer-readable storage media;
one or more processors operatively coupled with the one or more computer-readable storage media; and
program instructions stored on the one or more computer-readable storage media that, when executed by the one or more processors, direct the computing apparatus to at least:
receive natural language input from a user relating to a job, wherein the job is to be performed by one or more applications;
receive, from an artificial intelligence (AI) engine, a targeted portion generated by the AI engine, wherein the targeted portion includes information relating to the user with respect to the one or more applications;
generate a prompt with which to elicit a reply from a foundation model service, wherein the prompt includes a global portion and the targeted portion and wherein the prompt tasks the foundation model service with identifying one or more tasks relating to the job and identifying a recommended application in association with each task, wherein the recommended application is an application of the one or more applications recommended by the foundation model service for accomplishing the associated task; and
enable display of the one or more tasks and the one or more recommended applications from the foundation model service in a user interface.

2. The computing apparatus of claim 1, wherein the information relating to the user includes a skill level of the user with respect to the one or more applications.

3. The computing apparatus of claim 2, wherein the targeted portion further includes information relating to a subscription status of the user.

4. The computing apparatus of claim 3, wherein the targeted portion further includes one or more recommendations, wherein each of the one or more recommendations relates to an offer to be made to the user with respect to the subscription status of the user, and wherein the prompt further tasks the foundation model service with identifying a recommendation of the one or more recommendations relating to the application.

5. The computing apparatus of claim 3, wherein the targeted portion further includes functionalities of each of the one or more applications relating to the job.

6. The computing apparatus of claim 5, wherein the program instructions further direct the computing apparatus to send, to a recommended application of the one or more recommended applications, information relating to the associated task.

7. The computing apparatus of claim 6, wherein the information relating to the task includes a template.

8. The computing apparatus of claim 1, wherein the global portion comprises examples, wherein each of the examples includes an example job, one or more example tasks of the example job, and an application of the one or more applications associated with each of the one or more example tasks.

9. One or more computer-readable storage media having program instructions stored thereon that, when executed by one or more processors operatively coupled with the one or more computer-readable storage media, direct a computing device to:
receive natural language input from a user relating to a job, wherein the job is to be performed by one or more applications;
receive, from an artificial intelligence (AI) engine, a targeted portion generated by the AI engine, wherein the targeted portion includes information relating to the user with respect to the one or more applications;
generate a prompt with which to elicit a reply from a foundation model service, wherein the prompt includes a global portion and the targeted portion and wherein the prompt tasks the foundation model service with identifying one or more tasks relating to the job and identifying a recommended application in association with each task, wherein the recommended application is an application of the one or more applications recommended by the foundation model service for accomplishing the associated task; and
enable display of the one or more tasks and the one or more recommended applications from the foundation model service in a user interface.

10. The one or more computer-readable storage media of claim 9, wherein the information relating to the user includes a skill level of the user with respect to the one or more applications.

11. The one or more computer-readable storage media of claim 10, wherein the targeted portion further includes information relating to a subscription status of the user.

12. The one or more computer-readable storage media of claim 11, wherein the targeted portion further includes one or more recommendations, wherein each of the one or more recommendations relates to an offer to be made to the user with respect to the subscription status of the user, and wherein the prompt further tasks the foundation model service with identifying a recommendation of the one or more recommendations relating to the application.

13. The one or more computer-readable storage media of claim 11, wherein the targeted portion further includes functionalities of each of the one or more applications relating to the job according to the skill level of the user.

14. The one or more computer-readable storage media of claim 13, wherein the program instructions further direct the computing apparatus to send, to a recommended application of the one or more recommended applications, information relating to the associated task.

15. The one or more computer-readable storage media of claim 14, wherein the information relating to the task includes a recommended template.

16. The one or more computer-readable storage media of claim 9, wherein the global portion comprises examples, wherein each of the examples includes an example job, one or more example tasks of the job, and an application of the one or more applications associated with each of the one or more example tasks.

17. A method comprising:
receiving natural language input from a user relating to a job, wherein the job is to be performed by one or more applications;
receiving, from an artificial intelligence (AI) engine, a targeted portion generated by the AI engine, wherein the targeted portion includes information relating to the user with respect to the one or more applications;
generating a prompt with which to elicit a reply from a foundation model service, wherein the prompt includes a global portion and the targeted portion and wherein the prompt tasks the foundation model service with identifying one or more tasks relating to the job and identifying a recommended application in association with each task, wherein the recommended application is an application of the one or more applications recommended by the foundation model service for accomplishing the associated task; and
enabling display of the one or more tasks and the one or more recommended applications from the foundation model service in a user interface.

18. The method of claim 17, wherein the information relating to the user includes a skill level of the user with respect to the one or more applications.

19. The method of claim 18, wherein the targeted portion further includes information relating to a subscription status of the user.

20. The method of claim 19, wherein the targeted portion further includes one or more recommendations, wherein each of the one or more recommendations relates an offer to be made to the user with respect to the subscription status of the user.
